(19) United States
(12) Patent Application Publication
(10) Pub. No.: US 2006/0025487 A1
(43) Pub. Date: Feb. 2, 2006

(54) Sound-absorbing and soundproofing polyurethane composition

(76) Inventor: Paolo Scudieri, Ottaviano (IT)

Correspondence Address: STETINA BRUNDA GARRED & BRUCKER, 75 ENTERPRISE, SUITE 250, ALISO VIEJO, CA, 92656, US

(21) Appl. No.: 10/528,743

(22) PCT Filed: Sep. 24, 2003
(86) PCT No.: PCT/EP03/10619

§ 371 Date: Mar. 22, 2005

(30) Foreign Application Priority Data
Sep. 24, 2002 (IT) RM2002A000471

(51) Int. Cl. C08J 9/00

(52) U.S. Cl. 521/99

(57) ABSTRACT

Polyurethane foam composition that, owing to particular reagents for forming the s polyurethane foam itself and specific amounts of micronised inert fillers, such as fibreglass, silica, inorganic carbonates and textile fibres is able to achieve good sound-absorbing and soundproofing mechanical properties.

### TECHNICAL FIELD

This invention relates to a sound-absorbing and soundproofing polyurethane composition. More particularly, it relates to a polyurethane foam composition that, owing to particular reagents for forming the polyurethane and specific amounts of an inert filler is able to achieve good mechanical properties and very high performance in terms of sound insulation.

### BACKGROUND ART

In the area of sound-absorbing and/or soundproofing materials, several materials are used to filter and deaden sound; these are used in specific ways depending on the particular field of application.

Possible applications include sound conditioning home and work environments, piping (for example, drains), engine compartments, passenger compartments (in boats, cars, and trucks), and similar.

In all these applications, besides the sound insulation requirements, other qualities may also be important. Examples include the mechanical properties and the resistance to fuel, solvents, high or low temperatures, and sudden rises or falls in temperature. Furthermore, the sound-insulating performance should not vary significantly over time or when the material is compressed.

Attempts put forward to improve the performance of said materials have not produced the hoped for results. This is particularly true when limited dimensions and high absorptive power are required: the use of thin materials must be compensated for with high-density matter, increasing the weight, unless lower sound-insulating performance or limited mechanical properties are acceptable.

For example, U.S. Pat. No. 5,010,113 refers to a flame-retardant polyurethane material obtained by mixing and making react together an amino-salt of phosphoric acid, a compound containing at least two reactive hydrogens, and a compound containing at least two isocyanate radicals. Although the patent states that the resulting material has soundproofing properties, no mention is made of its actual insulating capacity or of its mechanical properties.

The German patent application n. 1991 412296-66 describes a sound-insulating viscoelastic foam. This foam has an adhesive surface and is obtained by making stoichiometric amounts of a polyisocyanate react with at least two polyols of the polyether type, which are incompatible with each other.

Patent no. EP0884349 describes a soundproofing material consisting of a reticular resin, chosen from the group comprising polyolefin, polystyrene, and polychlorovinyls crosslinked, —and containing an inert filler, preferably barium sulphate (referred to in the examples).

However, these documents do not make it clear what actual sound absorption coefficient is obtained, nor the effect of the inert filler other than to lower the cost of the finished product and to improve heat resistance.

### DESCRIPTION OF THE INVENTION

It is an object of the present invention to provide a viscoelastic polyurethane foam composition that offers excellent sound insulation and good mechanical properties. These properties do not change significantly when the composition is exposed to stress such as temperature changes, compression, and so forth.

Said composition is easy to manufacture in the form of slabs, bars, tubes, pressed parts, and similar and has a low specific weight, low impact strength, high pliability, and good mechanical properties.

Furthermore, the polyurethane composition in accordance with this invention is self-extinguishing.

In accordance with this invention, the polyurethane composition is obtained by mixing together, in the presence of amino catalysts and silicone stabilizers, (i) at least one polyol (component A)—chosen from polyether polyols with a functionality falling within the range from 3 to 8, molecular weight falling within the range from 200 to 10,000, and proportion of propylene oxides to ethylene oxides falling within the range from 80/15 to 50/50—with an initiator chosen from glycerine, triethanolamine, sorbitol and similar, and their mixtures, and polyester polyols; with (ii) an isocyanate (component B) chosen from toluene-diisocyanate and polymethylene polyphenyl isocyanate.

Components A and B are present in the reacting mixture in amounts expressed in percentages by weight falling within the range from 30 to 75% and from 20 to 65%, respectively; the remaining amount consists of compound C in addition to an amino catalyser and silicone stabilizer in amounts expressed in percentages by weight falling within the range from 0.20-1.00% and 0.40-1.00%, respectively.

Preferably, the polyether polyols of component A has a molecular weight falling within the range from 200 to 6000, more preferably from 2000 to 4000.

More particularly, the following may be used: polyether polyols with a molecular weight falling within the range from 5000 to 6000 and functionality equal to 3 with glycerine as initiator; polyether polyols with a high content of ethylene oxide (for example, around 50%), molecular weight around 4000, functionality of 3, and with glycerine as initiator; or, if rigid products should be obtained, a polyether polyol with a molecular weight falling within the range from 300 to 500 and sorbitol as initiator.

As is known, the molecular weight is also chosen as a function of the elasticity characteristics that the product must possess: the higher the molecular weight of the polyol, the greater the elasticity of the product.

Polyester polyols can be used in variable amounts ranging from 0 to 100% with respect to the polyether polyol and, when used in a mixture, are added in amounts of about 20-50% with respect to the polyether polyols, preferably around 50%.

Advantageously, polyester polyols obtained from recovered polyethylene terephthalate and dimethylterephtalate can be used to obtain end products with the same properties as the-ones obtained using polyether polyols. Experts in the field will be able to evaluate which polyester polyols can be used to that end.

An important aspect of this invention is the addition of a third component (component C) to the mixture made up of components A and B. Component C consists of at least one material chosen from fibreglass, carbonates, silica, and textile-fibres with maximum particle dimension falling within the range from 10 to 500 μm, preferably from 50 to 200 μm. Component C is added to the mixture in amounts expressed in percentages by weight falling within the range from 5 to 50%,. preferably from 10 to 30%.

When making the composition in accordance with this invention, pre-polymers may be used. These are obtained by reacting all the polyol with a small amount of isocyanate, typically from 2 to 8%, while keeping, in accordance with known techniques, the temperature reached during the reaction under tight control in order not to trigger uncontrolled polymerization. Components A and B may also react directly; in this case, the components, including the component C, are added separately to the mixing head of a foaming machine; then, the foam, still in liquid state, is injected into a mould. This invention is appropriate for making products, using the above-described composition, such as slabs (with a thickness typically falling within the range from 5 to 500 mm), cylinders, tubes, parallelepipeds, or bodies with a specific shape.

The following is a list of the main properties of the composition in accordance with this invention:
it can be made, maintaining good sound insulation qualities, with variable density within an extensive range, typically from 50 to 200 kg/m³;
compared with similar known products, it has a reduced impact strength of up to 5%;
it has an ultimate elongation of up to 150%;
it maintains excellent sound insulation properties even when compressed.

The following examples are given illustrative and nonlimiting of the scope of the invention.

### EXAMPLE 1

Two identical mixtures, in terms of reagents, were prepared to make the polyurethane foam:

7 kg of SPECFLEX NS POLYOL polyether polyol manufactured by the DOW CHEMICAL COMPANY (component A) and 3 kg of VORALUX HE isocyanate also made by the DOW CHEMICAL COMPANY (component B) were injected separately into the mixing head of a foaming machine; then, the resulting mixture was sent to a mould for making 20-mm thick slabs (L1) with a specific weight of 100 kg/m³. The obtained product featured the following properties: combustion velocity≦100 mm/min, springback time˜8 s, resistance to compressive stress=50 g/cm², and impact strength=1.

The same amounts of components A and B in addition to 1 kg of powdered silica (component C)—with a particle-size curve falling within the range from 70 to 140 μm, mostly from 80 to 120 μm—underwent the same treatment (see above) to make slabs (L2) having the same dimensions and specific weight. The obtained product featured the following properties: combustion velocity=self-extinguishing, springback time=6 s, resistance to compressive stress=65 g/cm², and impact strength=2.

Then, the slabs underwent a sound insulation test according to ASTM E 1050-90 and ASTM C 384-95. The obtained results are shown in Table 1.

TABLE 1

| | SOUND ABSORPTION (%) | | | | | | | | | | | |
|---|---|---|---|---|---|---|---|---|---|---|---|---|
| | FREQUENCY (Hz) | | | | | | | | | | | |
| | 500 | 1000 | 1500 | 2000 | 2500 | 3000 | 3500 | 4000 | 4500 | 5000 | 5500 | 6000 |
| L1 | 25 | 48 | 69 | 72 | 66 | 60 | 61 | 70 | 83 | 85 | 81 | 77 |
| L2 | 35 | 68 | 91 | 90 | 84 | 79 | 82 | 92 | 99 | 97 | 93 | 90 |

The results show that a 14 to 42% improvement (average improvement of 32%) is obtained in the sound absorption value.

### EXAMPLE 2

A 40-mm thick L2 slab made in accordance with the invention as described in Example 1, underwent a sound absorption test as is and compressed (thickness reduced by 75%). The obtained results are shown in Table 2.

TABLE 2

| | FREQUENCY (Hz) | | | | | |
|---|---|---|---|---|---|---|
| SLAB | 1000 | 2000 | 3000 | 4000 | 5000 | 6000 |
| 40-mm THICK | 85 | 95 | 92 | 93 | 91 | 95 |
| COMPRESSED BY | 76 | 74 | 79 | 81 | 86 | 85 |
| 75% | | | | | | |

### EXAMPLE 3

Proceeding in accordance with what is specified in example 1, 7 kg of component A were reacted with 3 kg of component B. To this mixture, 2 kg of fibreglass—with maximum particle size falling within the range from 130 to 180 μm, mostly from 150 to 160 μm—were added to make 30-mm thick slabs with a specific weight equal to 60, 97,146, and 160 kg/m³.

These slabs underwent sound absorption tests in accordance with Example 1. The obtained results are shown in Table 3.

TABLE 3

| | SOUND ABSORPTION (%) | | | | | |
|---|---|---|---|---|---|---|
| | FREQUENCY (Hz) | | | | | |
| DENSITY (kg/m³) | 1000 | 2000 | 3000 | 4000 | 5000 | 6000 |
| 60 | 62 | 65 | 71 | 82 | 88 | 83 |
| 97 | 68 | 72 | 79 | 89 | 91 | 90 |
| 146 | 73 | 80 | 84 | 94 | 95 | 90 |
| 160 | 78 | 84 | 89 | 95 | 96 | 94 |

1. A viscoelastic polyurethane foam composition characterised in that it is obtained by mixing together, in the presence of amino catalysts and silicone stabilizers, (i) at least one polyol (component A), —chosen from polyether polyols with a functionality falling within the range from 3 to 8, molecular weight falling within the range from 200 to 10,000, and proportion of propylene oxides to ethylene oxides falling within the range from 80/15 to 50/50—with an initiator chosen from glycerine, triethanolamine, sorbitol and similar, and their mixtures, and/or polyester polyols; with (ii) an isocyanate (component B) chosen from toluene-diisocyanate and polymethylene polyphenyl isocyanate; to the above mixture being added at least one micronized inert substance (component C) chosen from inorganic carbonates, silica, fibreglass, and textile fibres.

2. A polyurethane composition as claimed in claim 1 wherein the polyether polyols of the component A have a molecular weight falling within the range from 200 to 6000.

3. A polyurethane composition as claimed in claim 2 wherein said polyether polyols have a molecular weight falling within the range from 2000 to 4000.

4. A polyurethane composition as claimed in claim 1 wherein said polyether. polyols have a molecular weight falling within the range from 300 to 500.

5. A polyurethane composition as claimed in claim 1 wherein said polyester polyols, when present in a mixture with the polyether polyols, are added in a proportion ranging from 20 to 50% of the total polyols.

6. A polyurethane composition as claimed in claim 5 wherein the polyester polyols are added in a proportion approximately equal to 50% of the total polyols.

7. A polyurethane composition as claimed in claim 1 wherein said micronized inert substances have a maximum particle size falling within the range from 10 to 500 μm.

8. A polyurethane composition as claimed in claim 7 wherein said micronized inert substances have a maximum particle size falling within the range from 50 to 200 μm.

9. A polyurethane composition as claimed in claim 1 wherein the component C is added to the mixture in amounts expressed in percentages by weight falling within the range from 5 to 50%.

10. A polyurethane composition as claimed in claim 9 wherein said component C is added to the mixture in amounts expressed in percentages by weight falling within the range from 10 to 30%.

11. A polyurethane composition as claimed in claim 1 wherein the polyether and polyester polyols are present in component A in a proportion ranging from 0 to 100.

12. A polyurethane composition as claimed in claim 1 wherein components A and B are present in the reacting mixture in amounts expressed in percentages by weight falling within the range from 30-75% and 20-65%, respectively, the remaining amount consisting of compound C in addition to an amino catalyser and silicone stabilizer in amounts expressed in percentages by weight falling within the range from 0.20-1.00% and 0.40-1.00%,: respectively.

13. Manufactured items such as slabs, cylinders, tubes, parallelepipeds, and items of a specific shape made using the polyurethane composition as claimed in any of the above claims.
